(19) United States
(12) Patent Application Publication
(10) Pub. No.: US 2008/0224883 A1
(43) Pub. Date: Sep. 18, 2008

(54) SELECTION OF MOBILE STATION ALERT BASED ON SOCIAL CONTEXT

(75) Inventor: Von A. Mock, Boynton Beach, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/686,829

(22) Filed: Mar. 15, 2007

(51) Int. Cl. G08B 5/22

(52) U.S. Cl. 340/825.36

(57) ABSTRACT

A method (400) and a system (100) for selecting an alert mode for a first communication device (105). The method can include receiving at least one alert setting indicator (125, 130, 135, 145) from at least a second communication device (110, 115, 120, 140), processing the at least one alert setting indicator to identify an alert mode for the first communication device that corresponds to the at least one alert setting indicator, and automatically activating the identified alert mode on the first communication device.

### BACKGROUND OF THE INVENTION

1. Field of the Invention

The present invention generally relates to communication devices and, more particularly, to selection of communication device alert settings.

2. Background of the Invention

Communication devices, for example mobile stations, personal digital assistants, and the like, often provide a variety of user selectable alert settings. These settings typically include a vibration alert setting and a variety of standard ring tones that may be presented as audible alerts. Many communication devices also have the ability to store user selected audio files which also may be played back as audible alerts.

It is sometimes desirable for a communication device's audible alerts to be disabled, for example when the communication device user is at a formal gathering, such as a meeting or a religious ceremony. Unfortunately, communication device users sometimes forget to change their communication device settings prior to the start of the gathering. When an incoming call or message is received, the communication device's audible alert can interrupt the gathering, usually to the embarrassment of the communication device user.

### SUMMARY OF THE INVENTION

The present invention relates to a method of selecting an alert mode for a first communication device. The method can include receiving at least one alert setting indicator from at least a second communication device, processing the alert setting indicator to identify an alert mode for the first communication device that corresponds to the alert setting indicator, and automatically activating the identified alert mode on the first communication device. Receiving the alert setting indicator can include receiving at least one alert setting indicator from each of a plurality of additional communication devices. Each of the alert setting indicators can indicate a presently active alert mode on a respective one of the additional communication devices.

The method also can include associating each of the received alert setting indicators with a correlating alert mode selected from a plurality of available alert modes, and determining which of the available alert modes is associated with the most alert setting indicators. Further, the method can include identifying which of the plurality of communication devices are associated with contacts identified in at least one contact list accessed by the first communication device. In such an arrangement, processing the alert setting indicator can include exclusively processing alert setting indicators that are associated with contacts identified in the contact list.

In another aspect of the invention, the method can include determining whether the second communication device is associated with at least one contact identified in a contact list accessed by the first communication device. In this arrangement, processing the alert setting indicator can include conditionally processing the alert setting indicator based upon whether the second communication device is associated with the contact identified in the contact list. Further, receiving the alert setting indicator can include receiving a plurality of alert setting indicators, and processing the alert setting indicator can include processing alert setting indicators that are associated with the contact identified in the contact list. In another arrangement, receiving at least one alert setting indicator can include receiving a plurality of alert setting indicators and processing the alert setting indicator can include processing alert setting indicators that are associated with the contact group identified in the contact list.

The method also can include transmitting at least a second alert setting indicator to the second device, the second alert setting indicator indicating a presently active alert mode on the first communication device.

The present invention also relates to a method of indicating an alert mode to be automatically implemented on a communication device. Such method can include identifying when it is presently desirable for a particular alert mode to be activated on the communication device and automatically wirelessly transmitting an alert mode indicator detectable by the communication device. In one arrangement, identifying when it is presently desirable for the particular alert mode to be activated can include determining that a multimedia presentation is to be, or is being, presented. In another arrangement, identifying when it is presently desirable for the particular alert mode to be activated can include determining that a particular type of multimedia presentation is to be, or is being, presented. In yet another arrangement, identifying when it is presently desirable for the particular alert mode to be activated can include determining that a multimedia presentation is to be, or is being, presented at a particular time.

The method also can include receiving alert mode configuration settings. In this arrangement, identifying when it is presently desirable for the particular alert mode to be activated can include processing the received alert mode configuration settings.

The present invention also relates to a first communication device. The first communication device can include a transceiver that receives at least one alert setting indicator from at least a second communication device. The first communication device also can include a controller that processes the at least one alert setting indicator to identify an alert mode for the first communication device that corresponds to the alert setting indicator, and automatically activates the identified alert mode on the first communication device.

The transceiver can receive at least one alert setting indicator from each of a plurality of additional communication devices, each of the alert setting indicators indicating a presently active alert mode on a respective one of the additional communication devices. The controller can associate each of the received alert setting indictors with a correlating alert mode selected from a plurality of available alert modes and can determine which of the available alert modes is associated with the most alert setting indicators.

The controller also can identify which of the plurality of communication devices are associated with contacts identified in at least one contact list accessed by the first communication device, and the controller can exclusively process alert setting indicators that are associated with contacts identified in the contact list. Further, the controller can determine whether the second communication device is associated with at least one contact identified in a contact list accessed by the first communication device, and can conditionally process the alert setting indicator based upon whether the second communication device is associated with the contact identified in the contact list.

The transceiver can receive a plurality of alert setting indicators and the controller can process the alert setting indicators that are associated with the contact or contact group identified in the contact list. Further, the transceiver can transmit at least a second alert setting indicator to the second device, the second alert setting indicator indicating a presently active alert mode on the first communication device.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a communication device that is useful for understanding the present invention;

FIG. 3 depicts a block diagram of a signal generator that is useful for understanding the present invention;

FIG. 4 is a flowchart that is useful for understanding the present invention; and

FIG. 5 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

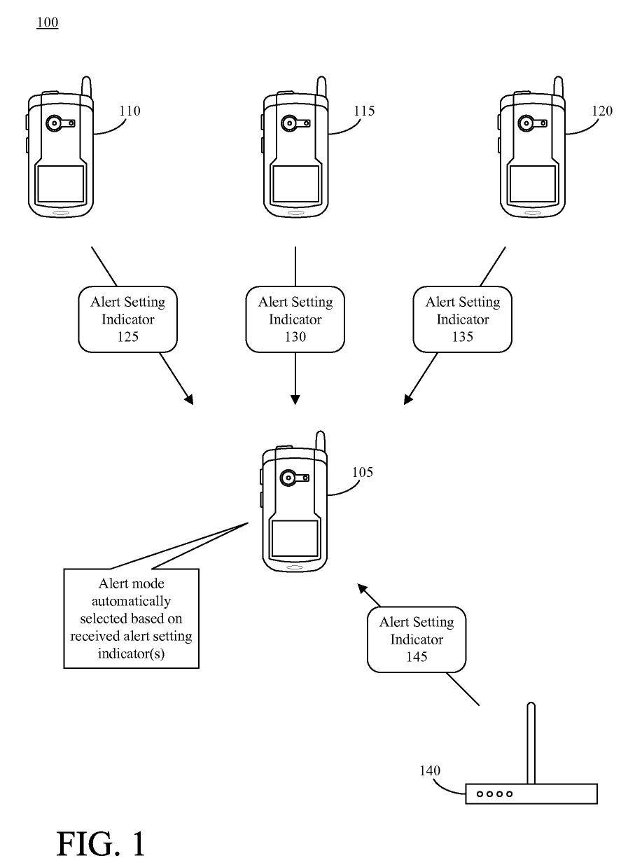

The present invention relates to a method and a system for selecting an alert mode for a communication device based on at least one alert setting indicator received from one or more other communication devices and/or a signal generator. FIG. 1 depicts a communications system 100 that is useful for understanding the present invention. The communications system 100 can include a first communication device 105. The communication device 105 can be a mobile station (e.g. a mobile telephone, a mobile radio, a mobile computer, a personal digital assistant, or the like), a conventional telephone (wired or wireless), a set top box (e.g. a multimedia receiver), a multimedia presentation system (e.g. a television, a video projection system, a stereo system, a surround sound system, a computer, or the like), or any other communication device that presents alerts.

The system 100 also can include one or more additional communication devices 110, 115, 120. The communication devices 110, 115, 120 can be mobile stations, conventional telephones, telephone answering machines, set top boxes, multimedia presentation systems, or any other communication devices which may include configurable alert settings. One or more of the communication devices 110-120 can wirelessly communicate a respective alert setting indicator 125, 130, 135 to the communication device 105.

Each of the alert setting indicators 125-135 can indicate a presently active alert mode on a respective communication device 110-120. For example, if the communication device 110 is presently set to a vibration alert mode, the alert setting indicator 125 can indicate vibration alert mode. If, however, the communication device 110 is presently set to a ringtone alert mode, the alert setting indicator 125 can indicate ringtone alert mode. Moreover, if the ringtone on the communication device 110 is set to a particular volume level, the alert setting indicator 125 can indicate the selected volume level. Other examples of alert settings that can be indicated by the alert setting indicators 125-135 can include, but are not limited to, a combination vibration and ringtone alert mode, a visual alert mode (e.g. an alert that is presented on a display or via an indicator lamp), a mode in which all alerts are disabled, a mode in which presentation of alerts are delayed, and so on.

In operation, the communication device 105 can receive one or more of the alert setting indicators 125-135 and process the received alert setting indicator(s) 125-135 to automatically identify an alert mode to be activated on the communication device 105. For example, the communication device 105 can process the alert setting indicators 125-135 to identify the most common alert mode that is presently active among the communication devices 110-120. To identify the most common alert mode, the communication device 105 can associate each of the received alert setting indictors 125-135 with a correlating alert mode selected from a plurality of available alert modes. The communication device 105 then can determine which of the available alert modes is associated with the most alert setting indicators 125-135. Still, the alert setting indicators 125-135 can be processed in any other suitable manner in order to identify the alert mode to be activated on the communication device 105. Regardless of how the alert mode is identified, once the identification is complete, the alert mode can be automatically activated on the communication device 105.

In one arrangement, the communication device 105 can filter the received alert setting indicators 125-135 that are received and identify the alert mode to be activated based on a subset of the received alert setting indicators 125-135. For example, the communication device 105 can conditionally process alert setting indicators 125-135 based upon whether alert setting indicators 125-135 are associated with contacts or contact groups identified in a contact list accessible by the communication device 105. Alert setting indicators 125-135 that are not associated with such contacts or contact group(s) can be disregarded. Determination of whether the alert setting indicators 125-135 are associated with contacts or contact groups can be based on one or more identifiers associated with the respective alert setting indicators 125-135.

Filtering of the alert setting indicators 125-135 can be user configurable. Thus, the communication device's alert settings can correspond to communication device alert settings implemented by other members of a particular social group identified by a user of the communication device 105. Still, the alert setting indicators 125-135 can be filtered in any other suitable manner and the invention is not limited in this regard.

In another aspect of the invention, the communication device 105 can include a user selectable setting to override automatic alert setting selection. Instead of the communication device's alert settings being automatically selected, a user of the communication device 105 can be presented information indicating alert settings implemented by one or more of the other communication devices 110-120. An alert configuration menu also can be automatically presented on the communication device 105 to facilitate alert mode selection if the user of the communication device 105 wishes to change the active alert mode. For example, the configuration menu can be presented on a display of the communication device 105.

In lieu of the communication devices 110, 115, 120, or in addition to the communication devices 110, 115, 120, the system 100 also can include a signal generator 140. The signal generator 140 can be a device that wirelessly transmits an alert setting indicator 145 detectable by the communication device 105. The signal generator 140 can be a mobile communication device or a stationary communication device.

The signal generator 140 can continuously transmit the alert setting indicator 145, periodically transmit the alert setting indicator 145, sporadically transmit the alert setting indicator 145, or transmit the alert setting indicator 145 in response to the signal generator 140 receiving an incoming signal. The incoming signal can be received from, for example, the communication device 105. By way of example, the signal generator 140 can be a transponder, a beacon generator, an access point, or any device suitable for generating the alert setting indicator 145. As previously described for the alert setting indicators 125-135, the alert setting indicator 145 can indicate a vibration alert mode, a ringtone alert mode, a ringtone volume, a combination vibration and ringtone alert mode, a visual alert mode, a mode in which all alerts are disabled, a mode in which presentation of alerts are delayed, or any other alert settings that may be desired.

The alert mode indicated by the alert setting indicator 145 can be based on alert mode configuration settings stored in, or communicated to, the signal generator 140. For example, the alert mode configuration settings can be communicated to the signal generator 140 from a communication device or processing device (not shown) to which the signal generator 140 is communicatively linked or in which the signal generator 140 is incorporated. Examples of such devices can include, but are not limited to, a computer, a mobile station, a set top box, a telephone, a telephone answering machine, etc. The alert mode configuration settings can be manually selected via a user interface, selected in accordance with a particular schedule, or selected in response to one or more conditions. For example, at times in which meetings or formal gatherings are scheduled, the signal generator 140 can generate the alert setting indicator 145 to indicate a vibration alert mode, a visual alert mode, and/or a mode in which all alerts are disabled at specific times. At other times, the alert setting indicator 145 can indicate a default alert mode, an audible alert mode, an alert mode in which multiple alerts are presented, or communication of the alert setting indicator 145 can be disabled.

In an arrangement in which the signal generator 140 is a component of a multimedia presentation system or a set top box, the signal generator 140 can generate the alert setting indicator 145 to indicate a particular alert mode to be implemented by the communication device 105 during a multimedia presentation (e.g. presentation of a movie, a television program, an audio program, music, a podcast, etc.). The signal generator 140 can generate the alert setting indicator 145 whenever multimedia is being presented, whenever a particular type of multimedia is being presented, when multimedia is being presented at a particular time, in accordance with a user configurable setting, or in response to any other suitable condition.

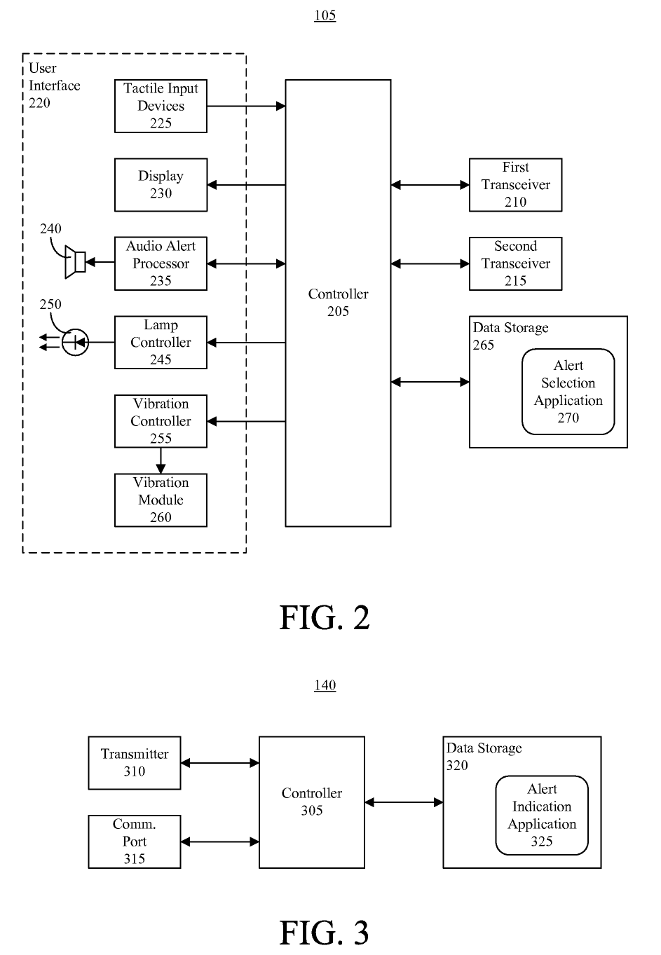

FIG. 2 depicts an example of the communication device 105 that is useful for understanding the present invention. The communication device 105 can include a controller 205. The controller 205 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The communication device 105 also can include a first transceiver 210. The first transceiver 210 can modulate and demodulate signals to convert signals from one form to another, and can transmit and/or receive such signals over one or more various wireless communication networks. In illustration, the first transceiver 210 can be configured to communicate data via IEEE 802 wireless communications, for example, 802.11 and 802.16 (WiMax), WPA, or WPA2. In another example, the transceiver 210 can communicate data via GSM, TDMA, CDMA, WCDMA, OFDM, or direct wireless communication. Further, the transceiver 210 also can be configured to communicate over a wireless communication link using any of a myriad of communications protocols, for example, TCP/IP.

The communication device 105 also can include a second transceiver 215. The second transceiver 215 also can modulate and demodulate signals to convert signals from one form to another. In one arrangement, the second transceiver 215 can be configured to communicate using near field communications (NFC). In another arrangement, the second transceiver 215 can be configured to communicate using Bluetooth, ZigBee, IEEE 802 wireless communications, WPA, WPA2, GSM, TDMA, CDMA, WCDMA or OFDM. In yet another arrangement, the second transceiver 215 can be configured to communicate via infrared signals.

Fewer or additional transceivers can be included within the communication device 105. As such, the particular number of transceivers included within the communication device 105 and/or the particular communication protocols used are not intended to limit the present invention. The alert setting indicators previously discussed can be received from the other communication devices and/or from the signal generator via the first transceiver 210 and/or the second transceiver 215. For example, in an arrangement in which the alert setting indicators are communicated in accordance with a near field communication (NFC) protocol, IEEE 802, Bluetooth, ZigBee, or infrared signaling, the alert setting indicators can be received via the second transceiver 215.

The communication device 105 also can include a user interface 220 comprising one or more tactile input devices 225 and a display 230. The tactile input devices 225 can comprise one or more buttons, keys, soft keys, sensors, or any other devices suitable for receiving a tactile user input. The display 230 can be a liquid crystal display (LCD), a liquid crystal on silicon (LCOS) display, a cathode ray tube (CRT), a plasma display, or any other suitable display. In one arrangement, the display 230 can comprise a touch screen that can receive tactile and/or stylus inputs and communicate such inputs to the controller 205. In one arrangement, visual alerts can be presented on the display 230 in response to one or more alert signals being generated by the controller 205. The visual alerts can be presented as messages, colors that are presented on the display 230, symbols that are presented on the display 230, or presented on the display 230 in any other suitable manner.

The user interface 220 further can include an audio processor 235 connected an output audio transducer 240 (e.g. loudspeaker). The audio processor 235 can be integrated with the controller 205 or provided as a separate component that is communicatively linked to the controller 205. The audio processor 235 can comprise a CPU, a DSP, an ASIC, a PLD, a plurality of discrete components that cooperate to process audio data, and/or any other suitable audio processing device. The audio processor 235 can receive one or more alert signals from the controller 205 and, in response, communicate audio alert signals to the output audio transducer 240. From the audio alert signals, the output audio transducer 240 can generate audibly detectable acoustic signals.

The user interface 220 also can include a lamp controller 245 and an indicator lamp 250. The lamp controller 245 can be integrated with the controller 205 or provided as a separate component that is communicatively linked to the controller 205. The indicator lamp 250 can be, for instance, a light emitting diode (LED), a light bulb, or any other suitable light emitting device. Visual alerts also can be presented via the indicator lamp 250. For example, the lamp controller 245 can illuminate the indicator lamp 250 in response to one or more alert signals being received from the controller 205. Such illumination can be a continuous illumination, a pulsed illumination, or presented in accordance with a particular alert pattern.

A vibration controller 255 and vibration module 260 also can be provided as components of the user interface 220. Again, the vibration controller 255 can be integrated with the controller 205 or provided as a separate component that is communicatively linked to the controller 205. Vibration alerts can be presented via the vibration module 260. For example, in response to one or more alert signals being received from the controller 205, the vibration controller 255 can provide a vibration control signal to the vibration module 260, thereby causing the vibration module 260 to vibrate the communication device 105.

Further, additional devices (not shown) can be components of the user interface 220. For instance, the user interface 220 also can include an input audio transducer (e.g. a microphone), a headset, a speakerphone, or other device(s) communicatively linked to the communication device 105 via the first transceiver 210 and/or the second transceiver 215.

The communication device 105 further can include data storage 265. The data storage 265 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 265 can be integrated into the controller 205, though this need not be the case.

An alert selection application 270 can be contained on the data storage 265. The controller 205 can execute the alert selection application 270 to implement the processes and methods described herein that are performed by the communication device 105. For example, the alert selection application 270 can process alert setting indicators received by the first transceiver 210 and/or the second transceiver 215 to identify an appropriate alert mode for the communication device 105. The alert selection application 270 then can select the identified alert mode and activate that alert mode on the communication device 105. The alert selection application 270 also can present to the user, via the user interface 220, information corresponding to the identified alert mode. In one arrangement, rather than automatically entering the communication device 105 into the identified alert mode, the alert selection application 270 can prompt the user to enter a user input indicating whether the identified alert mode is to be activated. Based on the user input, the alert selection application 270 can enter the communication device 105 into the identified alert mode, keep the communication device 105 in an existing alert mode, or initiate any other user indicated action.

The alert selection application 270 also can identify a current alert mode selected for the communication device 105 and transmit an alert setting indicator corresponding the current alert mode to one or more additional communication devices. The alert setting indicator can be transmitted in response to receiving a signal from another communication device, in response to identification of another communication device within proximity to the communication device 105, continuously transmitted, periodically transmitted, sporadically transmitted, or suitably transmitted in response to any received parameter or event.

FIG. 3 depicts an example of the signal generator 140 that is useful for understanding the present invention. The signal generator 140 can include a controller 305. The controller 305 can comprise, for example, one or more CPUs, one or more DSPs, one or more ASICs, one or more PLDs, a plurality of discrete components that can cooperate to process data, and/or any other suitable processing device. In an arrangement in which a plurality of such components are provided, the components can be coupled together to perform various processing functions as described herein.

The signal generator 140 also can include a transmitter 310. In one arrangement the transmitter can be a component of a transceiver, although this need not be the case. The transmitter 310 can modulate signals to convert signals from one form to another, and can transmit such signals over one or more various wireless communication networks. In illustration, the transmitter 310 can be configured to communicate data via IEEE 802 wireless communications, for example, 802.11 and 802.16 (WiMax), WPA, or WPA2. In another example, the transmitter 310 can communicate data via GSM, TDMA, CDMA, WCDMA, OFDM, or direct wireless communication. In yet another arrangement, the transmitter 310 can be configured to communicate using near field communications (NFC), Bluetooth, ZigBee, or infrared signaling. Further, the transmitter 310 also can be configured to communicate over a wireless communication link using any of a myriad of communications protocols, for example, TCP/IP.

The signal generator 140 further can include a communications port 315. The communications port 315 can comprise a parallel port, a serial port, a communications bus interface, a network adapter, or any other port suitable for communicating data. The communications port 315 can receive configuration settings to be processed by an alert indication application 325. In an arrangement in which the signal generator 140 comprises a receiver or transceiver, the configuration settings can be received by the receiver or the transceiver. A user interface (not shown) can be provided in lieu of, or in addition to, the communications port 315.

The signal generator 140 also can include data storage 320. The data storage 320 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 320 can be integrated into the controller 305, though this need not be the case.

The alert indication application 325 can be contained on the data storage 320. The controller 305 can execute the alert indication application 325 to implement the processes and methods described herein that are performed by the signal generator 140. For example, the alert indication application 325 can transmit, via the transmitter 310, an alert setting indicator. As noted, the alert setting indicator can be based on configuration settings stored in, or communicated to, the signal generator 140.

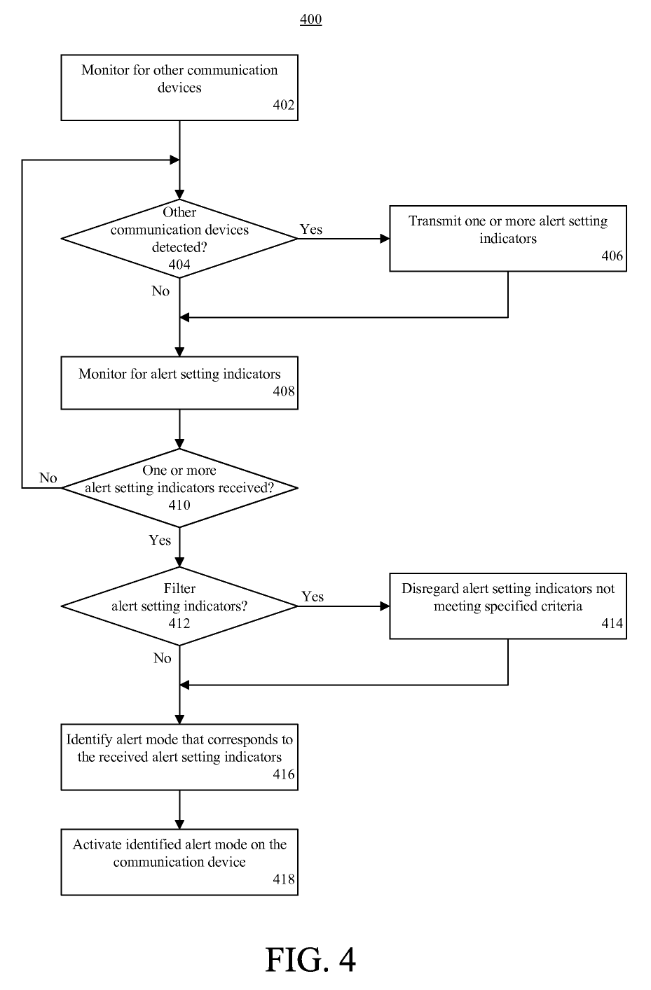

FIG. 4 is a flowchart presenting a method 400 that is useful for understanding the present invention. The method 400 can begin in a state in which a communication device has been configured to implement automatic alert mode selection and to automatically communicate an alert setting indicator to other communication devices. Beginning at step 402, the communication device can monitor for other communication devices. For instance, the communication device can monitor for identifiers transmitted by other communication devices.

Referring to decision box 404, if other communication devices are detected, at step 406 the communication device can transmit one or more alert setting indicators to the detected devices. In one arrangement, the alert setting indicators can be transmitted in an encrypted format so that only the detected communication devices can decipher the communicated information. In another arrangement, the alert setting indicators can be transmitted in a manner such that other devices which have not yet been detected also can process the alert setting indicators. In yet another arrangement, the communication device can transmit the alert setting indicators regardless of whether another communication device is detected. In such an arrangement, the alert setting indicators can be continuously transmitted, periodically transmitted, sporadically transmitted, or transmitted in accordance with a suitable transmission scheme.

Proceeding to step 408, the communication device can monitor for alert setting indicators transmitted by other communication devices and/or one or more signal generators. Continuing to decision box 410, if one or more alert setting indicators are received, for instance within a certain period, the process can proceed to decision box 412. At decision box 412, if the communication device is configured to filter alert setting indicators, at step 414 alert setting indicators not meeting specified criteria can be disregarded. For example, if the communication device is configured to only process alert setting indicators received from contacts identified in a particular contact list or contacts associated with a particular contact group, alert setting indicators received from communication devices not associated with the contacts or contact group can be disregarded.

In another arrangement, the communication device can be configured to prioritize received alert setting indicators. Further, alert setting indicators received from a particular device can be assigned higher priority than alert setting indicators received from other devices. For example, an alert setting indicator received from a particular type of signal generator can be given higher priority than an alert setting indicator received from a particular type of communication device. In this example, an alert setting indicator from the communication device can be disregarded when an alert setting indicator from the signal generator is detected. Importantly, this is merely an example of how filtering of alert setting indicators can be implemented. Indeed, any of a myriad of filtering schemes can be implemented and the invention is not limited in this regard.

At step 416, an alert mode that corresponds to the received alert setting indicators can be identified. The identification of the alert mode can be based on alert setting statistics, alert setting priorities, weightings assigned to alert mode indicators (e.g. based on social contexts), or any other suitable parameters. Proceeding to step 418, the identified alert mode can be activated on the communication device. As noted, the alert mode can be automatically activated, or a user can be prompted to activate the identified alert mode or disregard the alert mode selection.

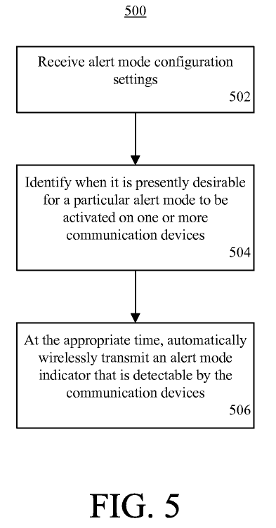

FIG. 5 is a flowchart presenting another method 500 that is useful for understanding the present invention. The method 500 can begin in a state in which a signal generator has been configured to transmit alert setting indicators. Beginning at step 502, the signal generator can receive alert mode configuration settings. As noted, the alert mode configuration settings can be entered into the signal generator via a user interface, received from a communication device, or received from another device to which the signal generator is communicatively linked.

At step 504, the signal generator can identify when it is presently desirable for a particular alert mode to be activated on one or more communication devices. For example, in one arrangement the signal generator can determine that a multimedia presentation is being presented or is to be presented, for instance at a particular time. The signal generator also can determine that a certain type of multimedia presentation is being presented or is to be presented. Such determinations can be performed by processing the alert configuration settings, as well as control signals received from a multimedia presentation device. As noted, the signal generator can be a component of the multimedia presentation device, or otherwise communicatively linked to the multimedia presentation device.

Proceeding to step 506, at the appropriate time (e.g. at a time identified in step 504), the signal generator can wirelessly transmit an alert mode indicator that is detectable by the communication devices. For example, the signal generator can transmit an alert mode indicator that indicates to the communication devices to activate a vibration alert mode, a visual alert mode, or to enter a mode in which alerts are deactivated.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method of selecting an alert mode for a first communication device, comprising:
receiving at least one alert setting indicator from at least a second communication device;
processing the at least one alert setting indicator to identify an alert mode for the first communication device that corresponds to the at least one alert setting indicator; and
automatically activating the identified alert mode on the first communication device.

2. The method of claim 1, wherein receiving the at least one alert setting indicator comprises receiving at least one alert setting indicator from each of a plurality of additional communication devices, each of the alert setting indicators indicating a presently active alert mode on a respective one of the additional communication devices.

3. The method of claim 2, wherein processing the received alert setting indicators comprises:
associating each of the received alert setting indicators with a correlating alert mode selected from a plurality of available alert modes; and
determining which of the available alert modes is associated with the most alert setting indicators.

4. The method of claim 2, further comprising:
identifying which of the plurality of communication devices are associated with contacts identified in at least one contact list accessed by the first communication device;
wherein processing the at least one alert setting indicator comprises exclusively processing alert setting indicators that are associated with contacts identified in the contact list.

5. The method of claim 1, further comprising:
determining whether the second communication device is associated with at least one contact identified in a contact list accessed by the first communication device;
wherein processing the alert setting indicator comprises conditionally processing the alert setting indicator based upon whether the second communication device is associated with the contact identified in the contact list.

6. The method of claim 5, wherein:
receiving at least one alert setting indicator comprises receiving a plurality of alert setting indicators; and
processing the alert setting indicator comprises processing alert setting indicators that are associated with the at least one contact identified in the contact list.

7. The method of claim 5, wherein:
receiving the at least one alert setting indicator comprises receiving a plurality of alert setting indicators; and
processing the alert setting indicator comprises processing alert setting indicators that are associated with the at least one contact group identified in the contact list.

8. The method of claim 1, further comprising transmitting at least a second alert setting indicator to the at least second device, the second alert setting indicator indicating a presently active alert mode on the first communication device.

9. A method of indicating an alert mode to be automatically implemented on a communication device, comprising:
identifying when it is presently desirable for a particular alert mode to be activated on the communication device;
automatically wirelessly transmitting an alert mode indicator detectable by the communication device.

10. The method of claim 9, wherein identifying when it is presently desirable for the particular alert mode to be activated comprises determining that a multimedia presentation is to be, or is being, presented.

11. The method of claim 9, wherein identifying when it is presently desirable for the particular alert mode to be activated comprises determining that a particular type of multimedia presentation is to be, or is being, presented.

12. The method of claim 9, wherein identifying when it is presently desirable for the particular alert mode to be activated comprises determining that a multimedia presentation is to be, or is being, presented at a particular time.

13. The method of claim 9, further comprising:
receiving alert mode configuration settings;
wherein identifying when it is presently desirable for the particular alert mode to be activated comprises processing the received alert mode configuration settings.

14. A first communication device, comprising:
a transceiver that receives at least one alert setting indicator from at least a second communication device; and
a controller that processes the at least one alert setting indicator to identify an alert mode for the first communication device that corresponds to the at least one alert setting indicator, and automatically activates the identified alert mode on the first communication device.

15. The first communication device of claim 14, wherein the transceiver receives at least one alert setting indicator from each of a plurality of additional communication devices, each of the alert setting indicators indicating a presently active alert mode on a respective one of the additional communication devices.

16. The first communication device of claim 15, wherein the controller associates each of the received alert setting indicators with a correlating alert mode selected from a plurality of available alert modes and determines which of the available alert modes is associated with the most alert setting indicators.

17. The first communication device of claim 15, wherein the controller identifies which of the plurality of communication devices are associated with contacts identified in at least one contact list accessed by the first communication device, and the controller exclusively processes alert setting indicators that are associated with contacts identified in the contact list.

18. The first communication device of claim 14, wherein the controller determines whether the second communication device is associated with at least one contact identified in a contact list accessed by the first communication device and conditionally processes the alert setting indicator based upon whether the second communication device is associated with the contact identified in the contact list.

19. The first communication device of claim 18, wherein the transceiver receives a plurality of alert setting indicators and the controller processes the alert setting indicators that are associated with the at least one contact or contact group identified in the contact list.

20. The first communication device of claim 14, wherein the transceiver transmits at least a second alert setting indicator to the at least second device, the second alert setting indicator indicating a presently active alert mode on the first communication device.
